(19) United States
(12) Patent Application Publication
(10) Pub. No.: US 2026/0259381 A1
(43) Pub. Date: Sep. 3, 2026

(54) OPTICAL CONNECTOR BOOT

(71) Applicant: Fujikura Ltd., Tokyo (JP)

(72) Inventor: Keisuke Nishiguchi, Sakura-shi (JP)

(73) Assignee: Fujikura Ltd., Tokyo (JP)

(21) Appl. No.: 18/866,261

(22) PCT Filed: Jan. 30, 2023
(86) PCT No.: PCT/JP2023/002781

§ 371 Date: Nov. 15, 2024

(30) Foreign Application Priority Data
Jun. 28, 2022 (JP) 2022-103566

(51) Int. Cl. G02B 6/38

(52) U.S. Cl. CPC G02B 6/38875

(57) ABSTRACT

An optical connector boot, that protects an optical fiber extending from an end portion of an optical connector, includes: a boot body including a center hole configured to accommodate the optical fiber; and a straight portion that extends from a rear end of the boot body and communicates with the center hole. The boot body has a slit that opens to an outer peripheral surface of the boot body and extends toward the center hole. In a case where a length of the straight portion is denoted by L, a section modulus of the straight portion is denoted by Z, and a longitudinal elastic modulus of the straight portion is denoted by E, the equation L[mm]/(Z[mm³]×E[MPa])≥1.25 [/mm² MPa] is satisfied.

### CROSS-REFERENCE TO RELATED APPLICATIONS

The present application is a national stage application of PCT Application No. PCT/JP2023/002781, filed on Jan. 30, 2023, which claims priority to Japanese Patent Application No. 2022-103566, filed on Jun. 28, 2022. The contents of these documents are incorporated by reference in their entirety.

### TECHNICAL FIELD

The present invention relates to an optical connector boot.

### BACKGROUND

In order to ensure the quality of an optical connector, tests according to the Telcordia standard (hereinafter, referred to as Telcordia tests) have been conducted conventionally. In the Telcordia test, the optical fiber extending from the optical connector is bent in multiple directions. In each direction, the transmission loss (bending loss) that occurs when the optical fiber is bent is measured, and it is determined whether the bending loss satisfies the standard. More specifically, in each direction, two types of tensile loads, namely a low load and a high load, are applied to the optical fiber, and the bending loss is evaluated for each of these two types of tensile loads.

In general, a boot for reducing bending loss is attached to a rear end of an optical fiber connector. For example, Patent Document 1 discloses a configuration in which a plurality of slits extending in a radial direction are arranged at intervals in a longitudinal direction of the boot. According to this configuration, when the optical fiber is bent, wall surfaces of the slits abut against each other, thereby suppressing the bending of the optical fiber and the bending loss caused by the bending.

### CITATION LIST

### Patent Document

Patent Document 1: Japanese Unexamined Patent Application, First Publication No. 2016-184009

In performing the Telcordia test, the boot elastically bends according to the magnitude of the load. That is, when the load is small, the bending of the boot is also small. In the conventional boot, when the load is relatively small, the boot may not bend sufficiently while the optical fiber tends to bend in the radial direction due to the load, resulting in the bending of the boot being smaller than the bending of the optical fiber. In this case, an abrupt bend occurs in the optical fiber at the rear end (free end) of the boot, leading to an increased likelihood of bending loss. Due to such a phenomenon, in the Telcordia test, there may be cases where the standard at a low load cannot be satisfied even when the standard at a high load is satisfied.

Here, a method of adjusting the length of the boot to make it easier to bend the boot is also considered. However, when this method is used, the length of the boot increases, hindering the reduction in size of the optical connector.

### SUMMARY

One or more embodiments of the present invention provide an optical connector boot, which can achieve both suppression of bending loss of an optical fiber in low-load tests and reduction of the length.

In one or more embodiments of the present invention, there is provided an optical connector boot that protects an optical fiber extending from an end portion of the optical connector, the boot including: a boot body in which a center hole through which the optical fiber is inserted is formed; and a tubular shaped straight portion that extends from a rear end of the boot body and communicate with the center hole, in which the boot body has a slit that opens to an outer peripheral surface of the boot body and extends toward the center hole, and in a case where a length of the straight portion is denoted by L, a section modulus of the straight portion is denoted by Z, and a longitudinal elastic modulus of the straight portion is denoted by E, L[mm]/(Z[mm³]×E[MPa]) ≥1.25 [/mm² MPa] is satisfied.

In one or more embodiments of the present invention, there is provided the optical connector boot as described above, in which the outer peripheral surface of the boot body includes a first tapered portion and a second tapered portion connected to a rear end of the first tapered portion and a front end of the straight portion, and the first tapered portion and the second tapered portion are inclined such that outer diameters thereof decrease toward a rear side.

In one or more embodiments of the present invention, there is provided the optical connector boot as described above, in which the boot body and the straight portion are integrally formed of the same material.

In one or more embodiments of the present invention, there is provided the optical connector boot as described above, in which the slit extends around an entire circumference of the boot body.

In one or more embodiments of the present invention, there is provided the optical connector boot as described above, in which the boot body includes two slits including the slit, and two thin portions located between the two slits and the center hole, the two slits are arranged at intervals in a longitudinal direction of the center hole, and a thickness of a thin portion located at a rear side among the two thin portions in a radial direction is equal to or less than a thickness of a thin portion located at a front side among the two thin portions in the radial direction.

In one or more embodiments of the present invention, there is provided the optical connector boot as described above, in which the boot body has a plurality of slits including the slit, the plurality of slits are arranged at intervals in a longitudinal direction of the center hole, and a slit located at a rearmost side among the plurality of slits communicates with the center hole.

According to one or more embodiments of the present invention, it is possible to provide an optical connector boot that achieves both the suppression of the bending loss of the optical fiber in low-load tests and the reduction of length.

### BRIEF DESCRIPTION OF DRAWINGS

FIG. 1 is a perspective view showing an optical connector according to one or more embodiments of the present invention.

FIG. 2 is a cross-sectional view taken along line II-II shown in FIG. 1.

FIG. 3 is a perspective view showing an optical connector boot according to one or more embodiments of the present invention.

FIG. 4 is a cross-sectional view taken along line IV-IV shown in FIG. 3.

FIG. 5A is a cross-sectional view taken along line VA-VA shown in FIG. 3.

FIG. 5B is a cross-sectional view taken along line VB-VB shown in FIG. 3.

FIG. 5C is a cross-sectional view taken along line VC-VC shown in FIG. 3.

FIG. 5D is a cross-sectional view taken along line VD-VD shown in FIG. 3.

FIG. 6 is a diagram showing a Telcordia test.

### DETAILED DESCRIPTION

Hereinafter, an optical connector boot 10 and an optical connector 1 using the optical connector boot 10 according to one or more embodiments of the present invention will be described with reference to the drawings.

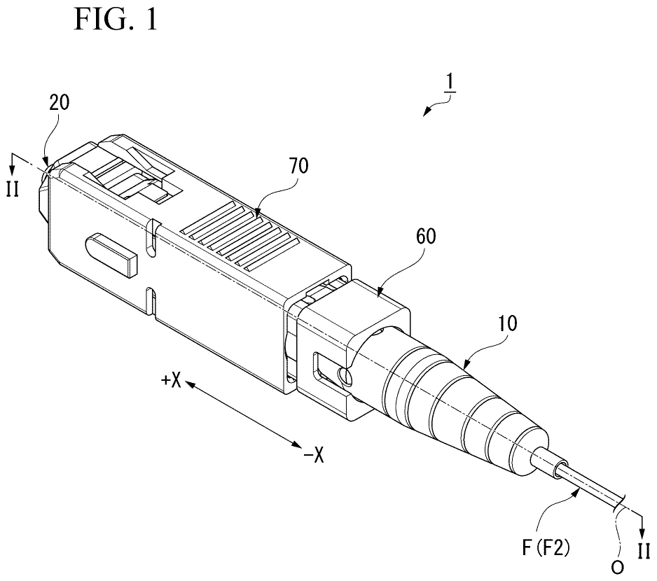

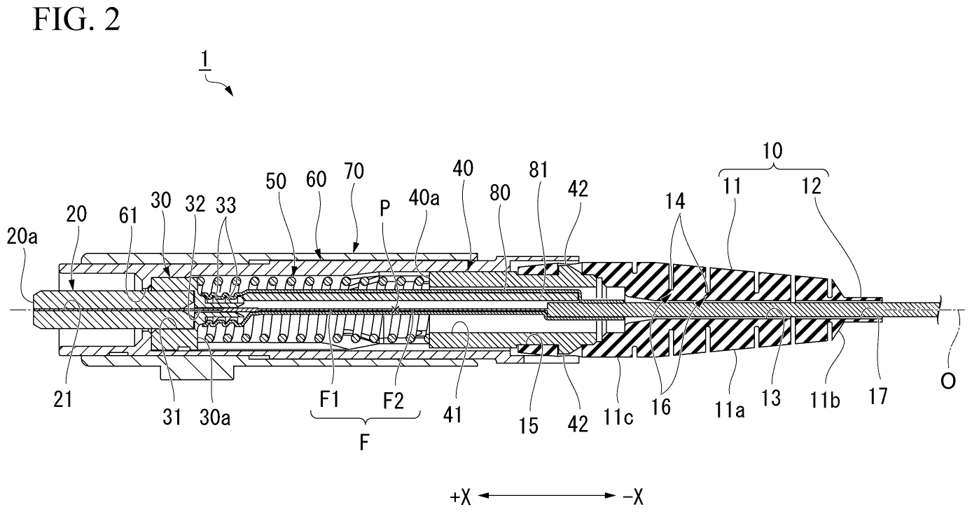

As shown in FIGS. 1 and 2, the optical connector 1 according to one or more embodiments includes the optical connector boot 10, a housing 60, and a case 70. As shown in FIG. 2, the housing 60 accommodates a ferrule 20, a holding member 30, the spring push 40, and the biasing member 50. Hereinafter, the optical connector boot 10 may be simply referred to as “boot 10”. It should be noted that the configuration of the optical connector 1, excluding the boot 10, is merely an example and can be appropriately modified. The optical connector 1 holds an optical fiber F. The optical fiber F extends from the end portion of the optical connector 1. As shown in FIG. 2, the boot 10 includes a boot body 11 and a straight portion 12. The boot body 11 and the straight portion 12 are tubular. The boot body 11 has a center hole 13, and the straight portion 12 has a communication hole 17. The communication hole 17 communicates with the center hole 13. The optical fiber F is inserted through the center hole 13 and the communication hole 17.

### Definition of Direction

Here, in one or more embodiments, a direction parallel to a central axis O of the center hole 13 of the boot 10 is referred to as an X direction, an axial direction X, or a longitudinal direction X. An orientation in which the optical fiber F extends from the optical connector 1 along the longitudinal direction X is referred to as a −X orientation or the rear side. The communication hole 17 opens toward the rear side. An orientation opposite to the −X orientation is referred to as a +X orientation or the front side. A cross section perpendicular to the longitudinal direction X is referred to as a transverse cross section. A direction orthogonal to the central axis O of the center hole 13 when viewed from the longitudinal direction X is referred to as the radial direction. Along the radial direction, an orientation closer to the central axis O is referred to as a radial-direction inner side, and an orientation separated from the central axis O is referred to as a radial-direction outer side. A direction that revolves around the central axis O when viewed from the longitudinal direction X is referred to as the circumferential direction. Hereinafter, the dimension in the longitudinal direction X may simply be referred to as “length”.

As shown in FIG. 2, the ferrule 20 has a connection end surface 20a where a fiber hole 21 is opened. The optical fiber F according to one or more embodiments includes a built-in fiber F1 that is inserted through the fiber hole 21 and fixed inside the fiber hole 21, and a connection fiber F2 that is connected to the rear end of the built-in fiber F1. The built-in fiber F1 and the connection fiber F2 are connected to each other, for example, by fusion. The built-in fiber F1 is fixed within the fiber hole 21 such that the distal end of the built-in fiber F1 is located at the connection end surface 20a.

A holding hole 31 that opens on the front side and a through-hole 32 that opens into the holding hole 31 and extends toward the rear side are formed in the holding member 30. The rear end portion of the ferrule 20 is inserted into the holding hole 31, whereby the holding member 30 holds the ferrule 20. The optical fiber F (built-in fiber F1) is inserted through the through-hole 32. The holding member 30 has a biased surface 30a that faces the rear side. A plurality of protrusions 33, which protrudes toward the radial-direction outer side from the outer peripheral surface of the holding member 30, are formed on the rear end portion of the holding member 30 according to one or more embodiments.

The spring push 40 is disposed at the rear side of the holding member 30. A through-hole 41 penetrating the spring push 40 in the longitudinal direction X is formed in the spring push 40. The optical fiber F (connection fiber F2) is inserted through the through-hole 41. The spring push 40 has a biasing surface 40a that faces the front side. A plurality of fixing protrusions 42, which protrudes toward the radial-direction outer side from the outer peripheral surface of the spring push 40, are formed on the rear end portion of the spring push 40. Although a detailed description thereof is omitted, the plurality of fixing protrusions 42 are arranged at intervals in the circumferential direction.

The housing 60 is a tubular member that accommodates the ferrule 20, the holding member 30, and the spring push 40. In addition, the case 70 is a tubular member and accommodates the housing 60. Although a detailed description thereof is omitted, the spring push 40 is fixed within the housing 60.

The biasing member 50 is interposed between the biased surface 30a of the holding member 30 and the biasing surface 40a of the spring push 40. The biasing member 50 biases the ferrule 20 toward the front side via the holding member 30 by being compressed between the biased surface 30a and the biasing surface 40a. For example, a coil spring can be used as the biasing member 50. In addition, at the front end portion of the housing 60 according to one or more embodiments, a restricting protrusion 61 is formed, which protrudes toward the radial-direction inner side from the inner peripheral surface of the housing 60. The restricting protrusion 61 abuts the front surface of the holding member 30 and prevents the holding member 30 and the ferrule 20 from falling toward the front side from the housing 60.

In one or more embodiments, a connection point P, where the built-in fiber F1 and the connection fiber F2 are connected, is protected by a heat-shrinkable sleeve 80. The heat-shrinkable sleeve 80 is a tubular member that can be contracted by heating. The heat-shrinkable sleeve 80 is heat-shrunk such that the connection point P, where the built-in fiber F1 and the connection fiber F2 are connected, is located inside the heat-shrinkable sleeve 80. In addition, the heat-shrinkable sleeve 80 according to one or more embodiments is heat-shrunk to tighten around the protrusion 33 of the holding member 30, thereby being fixed to the rear end portion of the holding member 30. As shown in the example of FIG. 2, a tensile strength member 81, which is disposed to be aligned with the connection point P, may be accommodated in the heat-shrinkable sleeve 80. According to this configuration, the connection point P can be more reliably protected.

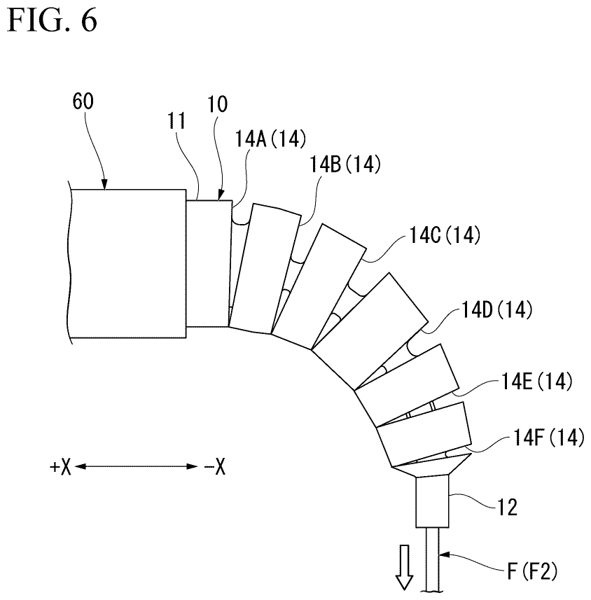

The boot 10 serves the role of protecting the optical fiber F (connection fiber F2) that extends toward the rear side from the optical connector 1. More specifically, the boot 10 is configured to elastically deform in response to the bending of the optical fiber F when a tensile load is applied to the optical fiber F in the radial direction (see also FIG. 6). The boot 10 serves the role of elastically receiving the bending of the optical fiber F and gently reducing the bending of the optical fiber F. In other words, the boot 10 serves the role of reducing the curvature of the optical fiber F.

As shown in FIGS. 2, 3, and 4, the straight portion 12 extends toward the rear side from the rear end of the boot body 11. The boot body 11 and the straight portion 12 are configured to be elastically deformable. Details will be described below, but the boot body 11 serves the role of elastically receiving a high load when the high load is applied to the optical fiber F and suppressing the bending of the optical fiber F. The straight portion 12 serves the role of elastically receiving the load when a low load is applied to the optical fiber F and suppressing the bending of the optical fiber F.

In one or more embodiments, the boot body 11 and the straight portion 12 are integrally formed from the same material. As a material for forming the boot body 11 and the straight portion 12, for example, an elastomer resin can be adopted. Examples of the elastomer resin include thermoplastic elastomer (TPE), thermoplastic styrenic elastomer (TPS), and thermoplastic vulcanizates (TPV).

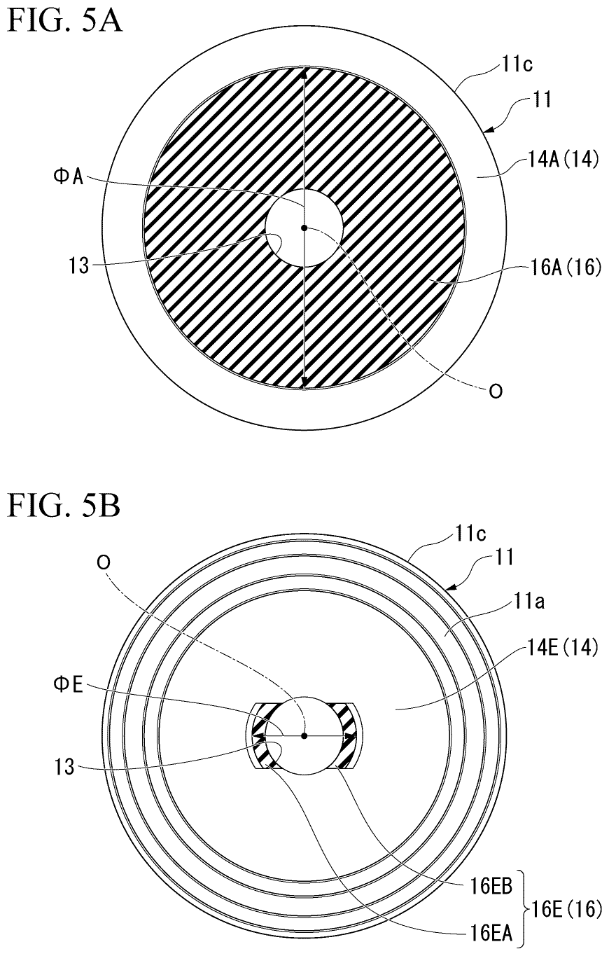

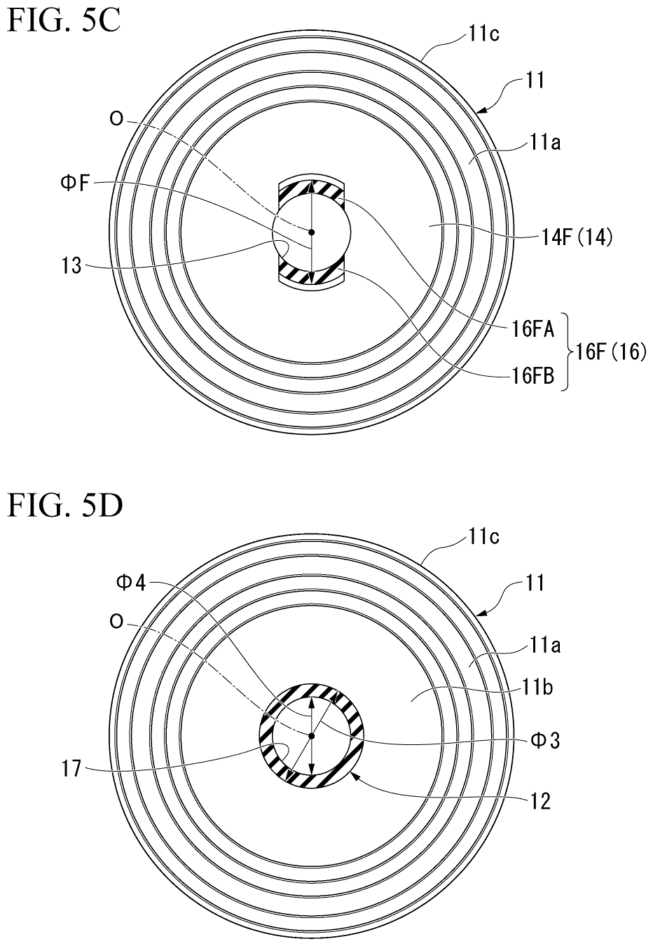

As shown in FIGS. 5A to 5D, in a transverse cross-sectional view, the center hole 13 and the communication hole 17 have a substantially circular shape. It should be noted that the expression “substantially circular shape” in the present specification also includes cases where the shape can be regarded as circular by ignoring manufacturing errors and elastic deformation. The center hole 13 is located at the center of the boot body 11 in the radial direction. The communication hole 17 is located at the center of the straight portion 12 in the radial direction.

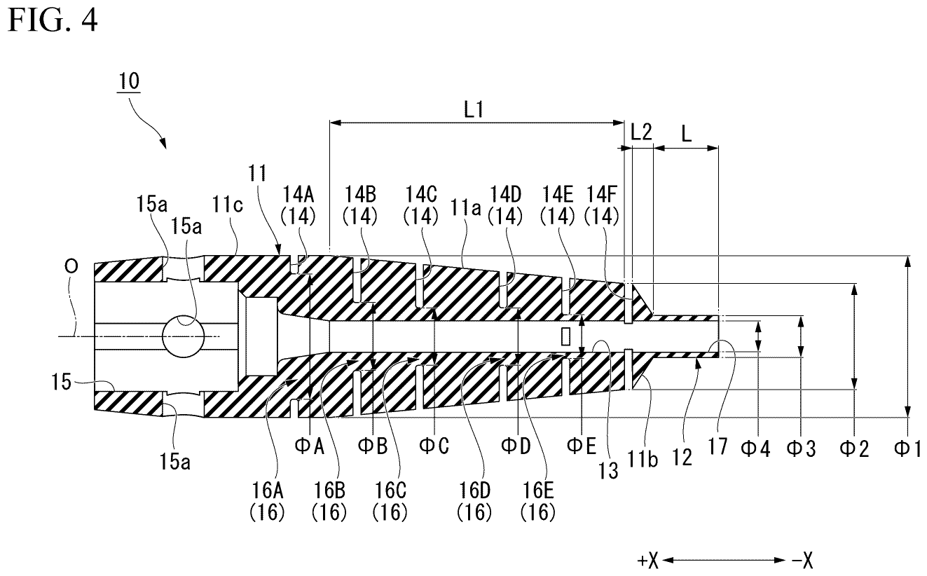

As shown in FIG. 4, the diameter of the communication hole 17 according to one or more embodiments is substantially constant at Φ4 in the longitudinal direction X. In other words, the inner diameter of the straight portion 12 according to one or more embodiments is substantially constant at Φ4 in the longitudinal direction X. It should be noted that the expression “substantially constant” in the present specification also includes cases where the value can be regarded as constant when manufacturing errors and elastic deformation are ignored. The inner diameter Φ4 of the straight portion 12 is, for example, approximately 1.6 mm.

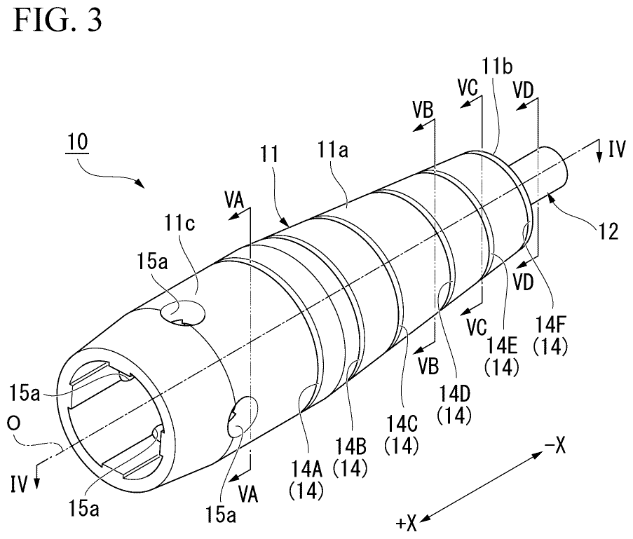

As shown in FIG. 2, an insertion hole 15 that opens toward the front side is formed in the boot body 11. The insertion hole 15 communicates with the center hole 13. The rear end portion of the spring push 40 is inserted into the insertion hole 15. As shown in FIG. 3, a plurality of fixing holes 15a are formed in the boot body 11, opening into the insertion hole 15 and extending to the outer peripheral surface of the boot body 11 toward the radial-direction outer side. In one or more embodiments, the number of fixing holes 15a is the same as the number of fixing protrusions 42 described above. The plurality of fixing holes 15a are arranged at intervals in the circumferential direction. As shown in FIG. 2, the boot body 11 according to one or more embodiments is attached to the rear end portion of the spring push 40 by inserting each of the plurality of fixing protrusions 42 into the plurality of fixing holes 15a.

As shown in FIG. 4, the outer peripheral surface of the boot body 11 according to one or more embodiments includes a non-tapered portion 11c, a first tapered portion 11a connected to the rear end of the non-tapered portion 11c, and a second tapered portion 11b connected to the rear end of the first tapered portion 11a and the front end of the straight portion 12. As shown in FIGS. 5A to 5C, each of the non-tapered portion 11c, the first tapered portion 11a, and the second tapered portion 11b has a substantially circular shape in a transverse cross-sectional view. In addition, as shown in FIG. 5D, the outer peripheral surface of the straight portion 12 has a substantially circular shape in a transverse cross-sectional view.

As shown in FIG. 4, the outer diameter of the non-tapered portion 11c is substantially constant in the longitudinal direction X. The first tapered portion 11a and the second tapered portion 11b are inclined such that outer diameters (diameters) thereof decrease toward the rear side. In addition, the inclination of the second tapered portion 11b with respect to the longitudinal direction X is greater than the inclination of the first tapered portion 11a with respect to the longitudinal direction X. In addition, the outer diameter of the straight portion 12 is substantially constant in the longitudinal direction X. An outer diameter Φ1 of the non-tapered portion 11c (front end of the first tapered portion 11a) is, for example, approximately 6.2 mm. An outer diameter Φ2 of the rear end of the first tapered portion 11a (front end of the second tapered portion 11b) is, for example, approximately 4.06 mm. An outer diameter Φ3 of the straight portion 12 (rear end of the second tapered portion 11b) is, for example, approximately 1.6 mm. In addition, the length L1 of the first tapered portion 11a (dimension in the longitudinal direction X) is, for example, approximately 11.3 mm. The length L2 of the second tapered portion 11b is, for example, approximately 0.8 mm. The length L of the straight portion 12 is, for example, approximately 2.5 mm.

As shown in FIGS. 3 and 4, a plurality of slits 14 (six in the shown example) are formed in the boot body 11, opening to the outer peripheral surface of the boot body 11 and extending toward the radial-direction inner side of the center hole 13. The plurality of slits 14 are arranged at intervals in the longitudinal direction X. Hereinafter, the six slits 14 are each referred to as a first slit 14A, a second slit 14B, a third slit 14C, a fourth slit 14D, a fifth slit 14E, and a sixth slit 14F, in the order from the front side to the rear side. In one or more embodiments, the first slit 14A opens into the non-tapered portion 11c. The second slit 14B, the third slit 14C, the fourth slit 14D, and the fifth slit 14E are opened to the first tapered portion 11a. The sixth slit 14F is opened at the boundary between the first tapered portion 11a and the second tapered portion 11b. As shown in FIG. 3, each of the slits 14A to 14F extends around the entire circumference of the boot body 11. In other words, each of the slits 14A to 14F is annularly opened on the outer peripheral surface of the boot body 11.

Since the slits 14A to 14F are formed in the boot body 11, the boot body 11 can exhibit the above-described function, that is, a function of elastically receiving the load when a high load is applied to the optical fiber F. Specifically, as shown in FIG. 6, when a high load is applied to the optical fiber F and the boot body 11 bends beyond a certain degree, the wall surfaces of the slits 14A to 14F abut against each other in the longitudinal direction X in each of the slits 14A to 14F. The wall surfaces of the slits 14A to 14F abut against each other, thereby suppressing the bending of the boot body 11 and the optical fiber F inserted through the boot body 11. In addition, since each of the slits 14A to 14F extends around the entire circumference of the boot body 11, the circumferential direction dependence (bending directionality) of the bendability of the boot body 11 can be reduced.

In addition, as shown in FIG. 4, since the slits 14A to 14F are formed, the thickness of the portion of the boot body 11 where the slits 14A to 14F are formed (the distance between the outer peripheral surface of the boot body 11 and the center hole 13 in the radial direction) is smaller than the thickness of the portion of the boot body 11 where the slits 14A to 14F are not formed. Hereinafter, each of the plurality of portions of the boot body 11, which are located between the plurality of slits 14A to 14F and the center hole 13 in the radial direction, is referred to as a thin portion 16. In particular, the portion located between the first slit 14A and the center hole 13 in the radial direction is referred to as the first thin portion 16A, and the portion located between the second slit 14B and the center hole 13 is referred to as the second thin portion 16B. Similarly, the portions located between the third slit 14C to the sixth slit 14F and the center hole 13 are each referred to as the third thin portion 16C to the sixth thin portion 16F (see also FIG. 5C).

FIG. 5A is a cross-sectional view taken along line VA-VA shown in FIG. 3, which is a cross-sectional view of the region where the first slit 14A is formed in the longitudinal direction. As shown in FIG. 5A, the first slit 14A does not communicate to the center hole 13. In addition, the first thin portion 16A has a substantially annular shape in a transverse cross-sectional view. Although a detailed description thereof is omitted, each of the second slit 14B to the fourth slit 14D, similarly to the first slit 14A, is not in communication with the center hole 13. Each of the second thin portion 16B to the fourth thin portion 16D has a substantially annular shape in a transverse cross-sectional view, similarly to the first thin portion 16A. It should be noted that the expression “substantially annular” in the present specification also includes cases where the shape can be regarded as annular when manufacturing errors and elastic deformation are ignored.

FIG. 5B is a cross-sectional view taken along line VB-VB shown in FIG. 3, which is a cross-sectional view of the region where the fifth slit 14E is formed in the longitudinal direction. As shown in FIG. 5B, the fifth slit 14E, unlike the slits 14A to 14D, communicates with the center hole 13 in a part in the circumferential direction. As a result, the fifth thin portion 16E does not have an annular shape in a transverse cross-sectional view. Specifically, the fifth thin portion 16E according to one or more embodiments includes two portions 16EA and 16EB that are spaced apart from each other in the circumferential direction. In other words, the fifth thin portion 16E has an annular shape with a partial cutout in the circumferential direction.

FIG. 5C is a cross-sectional view taken along line VC-VC shown in FIG. 3, which is a cross-sectional view of the region where the sixth slit 14F is formed in the longitudinal direction. As shown in FIG. 5C, the sixth slit 14F, like the fifth slit 14E, communicates with the center hole 13 in a part in the circumferential direction. As a result, the sixth thin portion 16F does not have an annular shape in a transverse cross-sectional view, and the sixth thin portion 16F includes two portions 16FA and 16FB that are spaced apart from each other in the circumferential direction. In other words, the sixth thin portion 16F has an annular shape with a partial cutout in the circumferential direction.

As described above, by adopting the configuration in which the slits 14E and 14F located at the rear end portion of the boot body 11 communicate with the center hole 13, the rigidity of the rear end portion of the boot body 11 can be reduced. As a result, the rear portion of the boot body 11 is more likely to bend in the radial direction compared to the front portion of the boot body 11, making it easier to reduce the curvature of the optical fiber F during load application. As shown in FIG. 5B and FIG. 5C, in one or more embodiments, the positions of the fifth thin portions 16EA and 16EB and the positions of the sixth thin portions 16FA and 16FB are shifted by 90° in the circumferential direction. As a result, it is possible to suppress the increase in the bending directionality of the boot body 11 caused by the partial cutout of the thin portions 16E and 16F in the circumferential direction.

In addition, as shown in FIG. 4, the thin portions 16A to 16F according to one or more embodiments are designed such that the thickness in the radial direction gradually decreases as the thin portions are further located on the rear side. The thickness of the thin portion 16 in the radial direction is hereinafter also referred to as “the thickness of the thin portion 16”. In other words, for each of two adjacent thin portions 16 in the longitudinal direction X, the thickness of the thin portion 16 located at the rear side of the two thin portions is equal to or less than the thickness of the thin portion 16 located at the front side of the two thin portions. In one or more embodiments, when the outer diameters of the first thin portion 16A to the sixth thin portion 16F are each denoted by ΦA to ΦF (see also FIG. 5C), ΦA≥ΦB≥ΦC≥ΦD≥ΦE≥ΦF is satisfied. The outer diameter ΦA of the first thin portion 16A is, for example, approximately 4.8 mm. The outer diameter B of the second thin portion 16B is, for example, approximately 2.6 mm. The outer diameter ΦC of the third thin portion 16C is, for example, approximately 2.2 mm. The outer diameter ΦD of the fourth thin portion 16D is, for example, approximately 2.2 mm. The outer diameter DE of the fifth thin portion 16E is, for example, approximately 1.6 mm. The outer diameter OF (see FIG. 5C) of the sixth thin portion 16F is, for example, approximately 1.6 mm.

By adopting a configuration where the thickness of the thin portion 16 gradually decreases as the thin portion 16 is located closer to the rear side, it is possible to achieve a rigidity distribution in the boot body 11 that gradually decreases from the front side to the rear side. As a result, the curvature of the optical fiber F during load application can be more effectively suppressed.

Meanwhile, when the tensile load applied to the optical fiber F is small, the bending of the boot body 11 also decreases. If the boot 10 has only the boot body 11, when the tensile load is relatively small, the boot body 11 may not bend sufficiently while the optical fiber F tends to bend in the radial direction due to the load, resulting in the bending of the boot body 11 being smaller than the bending of the optical fiber F. In this case, the optical fiber F is subjected to an abrupt bend at the rear end (free end) of the boot body 11, and the bending loss is likely to increase.

Therefore, the boot body 11 according to one or more embodiments has a straight portion 12 connected to the rear end of the boot body 11. The straight portion 12 elastically receives the optical fiber F at the rear end of the boot body 11 when a low load is applied to the optical fiber F, and serves the role of suppressing an increase in the curvature of the optical fiber F.

As a result of intensive studies by the present inventors, it has been found that the bending loss of the optical fiber F during load application can be suppressed by adjusting the length L of the straight portion 12, a section modulus Z of the straight portion 12, and a longitudinal elastic modulus (Young's modulus) E of the straight portion 12. It is considered that, by increasing the value of the length L, the contact area between the optical fiber F and the straight portion 12 is increased, making it easier to suppress the bending of the optical fiber F even during low load application. In addition, it is considered that by reducing the values of the section modulus Z and the longitudinal elastic modulus E, the straight portion 12 bends easily, allowing the straight portion 12 to bend in response to the bending of the optical fiber F.

### EXAMPLES

Hereinafter, one or more embodiments of conditions that are satisfied with regard to the length L, the section modulus Z, and the longitudinal elastic modulus E of the straight portion 12 will be described using specific examples. The present invention is not limited to the examples below.

### Example 1

A plurality of boots 10, where the lengths L of the straight portions 12 and the thicknesses of the straight portions 12 are different from each other, were prepared. In each of the plurality of boots 10, the longitudinal elastic modulus E of the straight portion 12 was 7.2 MPa in common, and the inner diameter Φ4 of the straight portion 12 was 0.9 mm in common. The expression “thickness of the straight portion 12” refers to the distance between the communication hole 17 and the outer peripheral surface of the straight portion 12 in the radial direction (see FIG. 4), and is represented by (Φ3−Φ4)/2.

The optical connector 1 was assembled using each boot 10, and a Telcordia test was performed on each optical connector 1. As shown in FIG. 6, in the Telcordia test, a load was applied to the optical fiber F in a direction perpendicular to the longitudinal direction X (that is, the radial direction). More specifically, two types of loads, which are a high load (0.7 kg) and a low load (0.25 kg), were applied to each of the eight directions perpendicular to the longitudinal direction X, and the bending loss was evaluated for each of two types of loads. In addition, for each optical connector 1, a simulation was performed to determine the degree of the displacement of the rear end (free end) of the straight portion 12 in the radial direction when a load of 1 g was applied to the optical fiber F. In addition, for each optical connector 1 (straight portion 12), the value of parameter A defined by the following equation a was calculated.

$$a : A [ / {mm}^{2} MPa ] = L [ mm ] / ( Z [ m {m}^{3} ] \times E [ MPa ] )$$

L: length of the straight portion 12
Z: section modulus of the straight portion 12
E: longitudinal elastic modulus of the straight portion 12
Table 1 summarizes the results of the above-described tests, the simulation results, and the calculated values of parameter A.

TABLE 1

| A = L/ZE [/mm² MPa] | | | | | | | | | | |
|---|---|---|---|---|---|---|---|---|---|---|
| Displacement [mm] | | Length L [mm] | | | | | | | | |
| Bending loss | | 1.0 | 1.1 | 1.2 | 1.3 | 1.4 | 1.5 | 2.0 | 2.5 | 3.0 |
| Thickness | 0.2 | 0.84 | 0.92 | 1.00 | 1.09 | 1.17 | 1.25 | 1.67 | 2.09 | 2.51 |
| (Φ3 − Φ4)/2 | | 0.015 | 0.016 | 0.018 | 0.020 | 0.022 | 0.024 | 0.036 | 0.055 | 0.082 |
| [mm] | | Bad | Bad | Bad | Bad | Bad | Good | Good | Good | Good |
| | 0.3 | 0.48 | 0.53 | 0.58 | 0.63 | 0.67 | 0.72 | 0.96 | 1.20 | 1.44 |
| | | 0.009 | 0.010 | 0.011 | 0.011 | 0.012 | 0.014 | 0.021 | 0.031 | 0.045 |
| | | Bad | Bad | Bad | Bad | Bad | Bad | Bad | Bad | Good |
| | 0.4 | 0.31 | 0.34 | 0.38 | 0.41 | 0.44 | 0.47 | 0.63 | 0.78 | 0.94 |
| | | 0.006 | 0.006 | 0.007 | 0.008 | 0.008 | 0.009 | 0.014 | 0.020 | 0.028 |
| | | Bad | Bad | Bad | Bad | Bad | Bad | Bad | Bad | Bad |
| | 0.5 | 0.22 | 0.24 | 0.26 | 0.28 | 0.30 | 0.33 | 0.43 | 0.54 | 0.65 |
| | | 0.004 | 0.005 | 0.005 | 0.006 | 0.006 | 0.007 | 0.010 | 0.014 | 0.019 |
| | | Bad | Bad | Bad | Bad | Bad | Bad | Bad | Bad | Bad |

Longitudinal elastic modulus E = 7.2 [MPa]

In Table 1, for each of the total 36 combinations of the length L and the thickness of the straight portion 12, the calculated value of parameter A is shown in the upper part, the simulation value of the displacement of the straight portion 12 is shown in the middle part, and the evaluation result of the bending loss in the low-load test is shown in the lower part. In “the evaluation result of the bending loss in the low-load test”, the cases where the maximum value of the bending loss in the eight directions was 0.50 dB or less were defined as “good,” and the cases where the maximum value of the bending loss exceeded 0.50 dB were defined as “bad”. Since the evaluation results of the bending loss in the high load test were “good” for all the boots 10, the description is omitted. In addition, since the straight portion 12 according to one or more embodiments has a substantially cylindrical shape, the section modulus Z was calculated using the following equation b. Table 2 is a table summarizing the calculated values of the section modulus Z. As described above, since the plurality of boots 10 have inner diameters Φ4 of 0.9 mm in common, the thickness is changed by changing the size of Φ3.

$$b : Z = ( π / 32 ) \times ( Φ {3}^{4} - Φ {4}^{4} ) / Φ3$$

TABLE 2

| | | Inner diameter Φ4 [mm] |
|---|---|---|
| Section modulus Z [mm³] | | 0.9 |
| Thickness | 0.2 | 0.166 |
| (Φ3 − Φ4)/2 | 0.3 | 0.288 |
| [mm] | 0.4 | 0.444 |
| | 0.5 | 0.639 |

As shown in Table 1, the larger the value of parameter A, the greater the displacement of the straight portion 12 during 1 g load application. That is, a positive correlation is observed between parameter A and the displacement of the straight portion 12. This indicates that by increasing the value of parameter A, the straight portion 12 can be bent in response to the bending of the optical fiber F even when an extremely low load, for example 1 g, is applied to the optical fiber F.

In addition, as shown in Table 1, in the boot 10 where the value of parameter A is 1.25 or more, the evaluation of the bending loss in the low-load test is “good”. On the other hand, in the boot 10 where the value of parameter A is less than 1.25, the evaluation of the bending loss in the low-load test is “bad”. As described above, by setting the value of parameter A to 1.25 or more, the bending loss of the optical fiber F in the low-load test can be suppressed.

### Example 2

A plurality of boots 10, where the lengths L of the straight portions 12 and the thicknesses of the straight portions 12 are different from each other and the inner diameters Φ4 were 0.9 mm in common, were prepared in the same manner as in the above-described example (Example 1). In the present example, unlike the above-described example (Example 1), the longitudinal elastic modulus E of the straight portion 12 was 3.9 MPa in common in the plurality of boots 10. Table 3 summarizes the results of the low-load test, the simulation results, and the calculated values of parameter A for the boot 10 according to the present example.

TABLE 3

| A = L/ZE [/mm² MPa] | | | | | | |
|---|---|---|---|---|---|---|
| Displacement [mm] | | Length L [mm] | | | | |
| Bending loss | | 1.0 | 1.5 | 2.0 | 2.5 | 3.0 |
| Thickness | 0.2 | 1.54 | 2.31 | 3.09 | 3.86 | 4.63 |
| (Φ3 − Φ4)/2 | | 0.028 | 0.043 | 0.067 | 0.102 | 0.151 |
| [mm] | | Good | Good | Good | Good | Good |
| | 0.3 | 0.89 | 1.33 | 1.78 | 2.22 | 2.67 |
| | | 0.016 | 0.025 | 0.038 | 0.057 | 0.083 |
| | | Bad | Good | Good | Good | Good |
| | 0.4 | 0.58 | 0.87 | 1.15 | 1.44 | 1.73 |
| | | 0.011 | 0.017 | 0.025 | 0.036 | 0.052 |
| | | Bad | Bad | Bad | Good | Good |
| | 0.5 | 0.40 | 0.60 | 0.80 | 1.00 | 1.20 |
| | | 0.008 | 0.012 | 0.018 | 0.025 | 0.036 |
| | | Bad | Bad | Bad | Bad | Bad |

Longitudinal elastic modulus E = 3.9 [MPa]

Also in the present example, the larger the value of parameter A, the greater the displacement of the straight portion 12 during 1 g load application. In addition, in the boot 10 where the value of parameter A is 1.25 or more, the evaluation of the bending loss in the low-load test is “good”. On the other hand, in the boot 10 where the value of parameter A is less than 1.25, the evaluation of the bending loss in the low-load test is “bad”. That is, even in the present example where the longitudinal elastic modulus E of the straight portion 12 differs from that in Example 1, the bending loss of the optical fiber F in the low-load test can be suppressed by setting the value of parameter A to 1.25 or more.

In consideration of the above description, in one or more embodiments, there is provided the optical connector boot 10 that protects the optical fiber F extending from the end portion of the optical connector 1, the boot including: the boot body 11 in which the center hole 13 through which the optical fiber F is inserted is formed; and the straight portion 12 that extends from a tubular shaped rear end of the boot body 11 and communicate with the center hole 13, in which the boot body 11 has the slits 14 that open to an outer peripheral surface of the boot body 11 and extends toward the center hole 13, and in a case where a length of the straight portion 12 is denoted by L, a section modulus of the straight portion 12 is denoted by Z, and a longitudinal elastic modulus of the straight portion 12 is denoted by E, L[mm]/(Z[mm³]×E[MPa])≥1.25 [/mm² MPa] is satisfied.

According to this configuration, it is possible to suppress the bending loss of the optical fiber F in the low-load test. In addition, to satisfy L/ZE≥1.25, methods other than increasing the length L of the straight portion 12 can be adopted, such as reducing the section modulus Z or the longitudinal elastic modulus E of the straight portion 12. That is, by adjusting the section modulus Z and the longitudinal elastic modulus E of the straight portion 12, the bending loss of the optical fiber F can be suppressed without making the value of the length L of the straight portion 12 excessive. As a result, it is possible to achieve both the suppression of the bending loss of the optical fiber F and the reduction of the length of the boot 10.

In addition, the outer peripheral surface of the boot 10 may include the first tapered portion 11a and the second tapered portion 11b, which is connected to a rear end of the first tapered portion 11a and a front end of the straight portion 12. The first tapered portion 11a and the second tapered portion 11b may be inclined such that outer diameters thereof decrease toward the rear side. According to this configuration, in the boot body 11, it is possible to achieve a section modulus distribution where the section modulus gradually decreases from the front side to the rear side. As a result, it is possible to effectively reduce the curvature of the optical fiber F during load application. Further, the provision of the second tapered portion 11b can suppress the occurrence of discontinuous bending at the connection portion between the boot body 11 and the straight portion 12.

In addition, the boot body 11 and the straight portion 12 may be integrally formed from the same material. According to this configuration, the boot 10, which includes the boot body 11 and the straight portion 12, can be easily manufactured.

In addition, the slit 14 may extend around the entire circumference of the boot body 11. According to this configuration, the bending directionality of the boot body 11 (boot 10) can be reduced.

In addition, the boot body 11 includes a plurality of slits 14A to 14F and a plurality of thin portions 16A to 16F located between the plurality of slits 14A to 14F and the center hole 13. The plurality of slits 14A to 14F are arranged at intervals in the longitudinal direction X. For each of two adjacent thin portions 16 in the longitudinal direction X, among the two thin portions 16, the thickness of the thin portion 16 located at the rear side may be equal to or less than the thickness of the thin portion 16 located at the front side. According to this configuration, it is possible to achieve a rigidity distribution in which the rigidity gradually decreases from the front side to the rear side in the boot body 11. As a result, it is possible to more effectively reduce the curvature of the optical fiber F during load application.

In addition, the slit 14F located at the rearmost side among the plurality of slits 14A to 14F may communicate with the center hole 13. According to this configuration, the rigidity of the rear end portion of the boot body 11 can be reduced. As a result, the rear portion of the boot body 11 is more likely to bend in the radial direction compared to the front portion of the boot body 11, making it easier to reduce the curvature of the optical fiber F during load application.

Note that, the technical scope of the present invention is not limited to the above-described embodiments, and various modifications can be made without departing from the spirit of the present invention.

For example, the boot body 11 and the straight portion 12 may be formed from different materials.

In addition, the number and the position of the slits 14 provided in the boot body 11 can be appropriately changed. In addition, the number and the position of the slits 14 communicating with the center hole 13 can be appropriately changed. The slit 14 that communicates with the center hole 13 may not be present. For example, in the above-described embodiments, the fifth thin portion 16E of the fifth slit 14E and the sixth thin portion 16F of the sixth slit 14F may have a substantially annular shape in a transverse cross-sectional view.

In addition, at least one set of two thin portions 16 adjacent to each other in the longitudinal direction X, in which the relationship “the thickness of the thin portion 16 located at the rear side is equal to or less than the thickness of the thin portion 16 located at the front side” is satisfied, may be provided. Alternatively, such a set of two thin portions 16 may not be present.

Alternatively, the boot body 11 may not be formed with the slit 14 and the thin portion 16.

In addition, the outer peripheral surface of the boot body 11 may not have the first tapered portion 11a or the second tapered portion 11b.

In addition, the various dimensions L, L1, L2, Φ1 to Φ3, and ΦA to DF in the embodiments are all examples and can be appropriately changed.

In addition, it is possible to appropriately replace the constituent elements in the above-described embodiments with well-known constituent elements, and the above-described embodiment and modification examples may be appropriately combined without departing from the spirit of the present invention.

### REFERENCE SIGNS LIST

1: Optical connector
10: Boot (optical connector boot)
11: Boot body
11a: First tapered portion
11b: Second tapered portion
12: Straight portion
13: Center hole
14: Slit
16: Thin portion
X: Longitudinal direction

1. An optical connector boot that protects an optical fiber extending from an end portion of an optical connector, the boot comprising:
a boot body including a center hole configured to accommodate the optical fiber; and
a straight portion that extends from a rear end of the boot body and communicates with the center hole, wherein
the boot body has a slit that opens to an outer peripheral surface of the boot body and extends toward the center hole, and
in a case where a length of the straight portion is denoted by L, a section modulus of the straight portion is denoted by Z, and a longitudinal elastic modulus of the straight portion is denoted by E, the equation L[mm]/(Z[mm³]×E[MPa])≥1.25 [/mm² MPa] is satisfied.

2. The optical connector boot according to claim 1, wherein
the outer peripheral surface of the boot body includes:
a first tapered portion; and
a second tapered portion connected to a rear end of the first tapered portion and a front end of the straight portion, and
the first tapered portion and the second tapered portion are inclined such that outer diameters thereof decrease toward a rear side of the boot.

3. The optical connector boot according to claim 1, wherein
the boot body and the straight portion are integrally formed of the same material.

4. The optical connector boot according to claim 1, wherein
the slit extends around an entire circumference of the boot body.

5. The optical connector boot according to claim 1, wherein
the boot body includes two slits including the slit, and two thin portions located between the two slits and the center hole,
the two slits are arranged at intervals in a longitudinal direction of the center hole, and
a thickness of a thin portion located at a rear side among the two thin portions in a radial direction is equal to or less than a thickness of a thin portion located at a front side among the two thin portions in the radial direction.

6. The optical connector boot according to claim 1, wherein
the boot body has a plurality of slits including the slit,
the plurality of slits are arranged at intervals in a longitudinal direction of the center hole, and
a slit located at a rearmost side among the plurality of slits communicates with the center hole.
